(19) United States
(12) Patent Application Publication
(10) Pub. No.: US 2013/0254133 A1
(43) Pub. Date: Sep. 26, 2013

(54) PROACTIVE EVIDENCE DISSEMINATION

(71) Applicant: RISKJOCKEY, INC., Alpharetta, GA (US)

(72) Inventors: Michael A. Connell, Alpharetta, GA (US); Andrew J. Bone, Cumming, GA (US)

(73) Assignee: RiskJockey, Inc., Alpharetta, GA (US)

(21) Appl. No.: 13/848,584

(22) Filed: Mar. 21, 2013

Related U.S. Application Data
(60) Provisional application No. 61/613,810, filed on Mar. 21, 2012.

(51) Int. Cl. G06Q 10/00

(52) U.S. Cl. CPC G06Q 10/00
USPC 705/342

(57) ABSTRACT

A secure evidence sharing engine may facilitate and/or aid in the sharing of evidence documentation between providers and recipients of such information. In some examples, the engine may receive, from a client device, some identification information associated with a user. Additionally, the user, requesting or purchasing evidence can identify further parties to notify. At a later date, evidentiary documentation may be received regarding an item associated with the user. The secure evidence sharing engine may notify the user and identified parties that the evidentiary documentation is available for access. The interested parties may then access the evidentiary documentation after agreeing to terms and conditions and possibly paying a fee. Upon receipt of new evidence after an initial notification, the user and identified parties may receive notification of the new evidence and may choose to access the new evidence in a similar manner.

### CROSS-REFERENCES TO RELATED APPLICATIONS

This application claims the benefit of U.S. Provisional Application No. 61/613,810, filed Mar. 21, 2012, titled “Proactive Evidence Dissemination,” and having Attorney Docket No. 92245-832207 (000200US), the contents of which is hereby incorporated in its entirety by reference.

### FIELD OF THE INVENTION

This invention pertains generally to dissemination of evidence and, more particularly, to dissemination of evidence among parties with a legal interest in the evidence.

### BACKGROUND OF THE INVENTION

Following an incident requiring assistance or involvement of a law enforcement agency, a party to the event often requires access to evidentiary documentation maintained by a law enforcement agency. This evidentiary documentation may exist in several forms. For instance, police reports are created to document the officer's observations at the scene, general information about the incident and parties involved, and statements from witnesses and parties to the incident. Additionally, in many areas, police vehicles are equipped with cameras to produce video evidence for use at trial. The cameras are invaluable for documenting interactions between the police and the public. In some jurisdictions, police officers don cameras on their person for the same reason.

To obtain evidentiary documentation an interested party typically submits a request to a law enforcement agency, usually accompanied by a fee. Law enforcement agencies currently gather and store evidence at extraordinary cost, sharing evidence via CD/DVD, and mailing evidence to interested parties only after checks or money order have been processed, or open records requests have been received. The efficiency of the insurance agency processing a corresponding claim is usually negatively impacted due to the length of time it requires for information to be processed by the department. Additionally, the department may be under various obligations to maintain these types of records for various lengths of time, for example, as defined by statute. The sheer number of video, audio and other records may make organizing and managing this evidence a daunting task. As a result, wait times may be lengthy before the department is able to produce the evidence and deliver it to the requesting party. This delay may adversely impact the requesting party's ability to seek redress.

Embodiments of the invention are directed toward solving these and other problems individually and collectively.

### BRIEF SUMMARY OF THE INVENTION

As part of a system or method for secure evidence sharing between providers and recipients of evidentiary documentation, identification information associated with an interested party may be received. Following, or during, an incident involving law enforcement assistance or involvement, evidentiary documentation associated with the incident may be received, for example, from a law enforcement agency. For example, such evidentiary documentation may include an electronic copy of at least one of: a police report, an in-car video, an officer worn video, an eyewitness account, or any suitable document created with the expectation that the document may be used as evidence at trial, or any suitable combination thereof. An interested party may be identified as a party having legal interest in the object of outcome of the incident involving law enforcement. The identification may be based at least in part on the received identification information or information associated with the received evidentiary documentation. The identified interested parties may be notified with respect to the received evidentiary documentation.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

For a fuller understanding of the nature and advantages of the present invention, reference should be made to the ensuing detailed description and accompanying drawings.

### BRIEF DESCRIPTION OF THE DRAWINGS

Various embodiments in accordance with the present disclosure will be described with reference to the drawings, in which:

FIG. 1 illustrates an example secure evidence sharing environment in which various embodiments can be implemented;

FIG. 2 illustrates an example architecture in accordance with various embodiments;

FIG. 3 is a schematic diagram depicting aspects of an example graphical user interface used to collect new user registration data in accordance with at least one embodiment;

FIG. 4 is a schematic diagram depicting aspects of an example graphical user interface used to allow a user to submit an evidence request in accordance with at least one embodiment;

FIG. 5 is a schematic diagram depicting aspects of an example graphical user interface used to collect data regarding a provider payment type selection in accordance with at least one embodiment;

FIG. 6 is a schematic diagram depicting aspects of an example graphical user interface used to create a case file in accordance with at least one embodiment;

FIG. 7 is a schematic diagram depicting aspects of an example graphical user interface used to upload evidentiary documentation in accordance with at least one embodiment;

FIG. 8 is a schematic diagram depicting aspects of an example graphical user interface used to navigate a case file in accordance with at least one embodiment;

FIG. 9 is a schematic diagram depicting aspects of an example graphical user interface used to enter billing information in accordance with at least one embodiment;

FIG. 10 illustrates an example environment in which data objects are gathered from multiple source data stores in accordance with various embodiments;

FIG. 11 is a flowchart illustrating example steps for secure evidence sharing in accordance with at least one embodiment;

FIG. 12 is a flowchart illustrating further example steps for secure evidence sharing in accordance with at least one embodiment; and

FIG. 13 is a flowchart illustrating further example steps for secure evidence sharing in accordance with at least one embodiment; and

FIG. 14 illustrates an environment in which various embodiments can be implemented.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Techniques described and suggested herein are directed to secure evidence sharing between providers and recipients of electronic evidentiary documentation, for example, utilizing one or more computing systems. As used herein, the term “secure” relates to the process in which data from multiple sources is gathered and compared to identification information of a person in order to determine that the person has a legal interest in the object or outcome of an incident involving law enforcement. As used herein, “identification information” refers to any information that may be used in relation to identifying a party. Examples of identification information include a name, address, phone number, policy number, vehicle identification number, property parcel number, to name a few. As used herein, the term “electronic evidentiary documentation” includes any suitable documentation of evidence in the legal sense having an electronic representation. Examples of electronic evidentiary documentation include an electronic copy of a police report, an in-car video, an officer worn video, an eyewitness account, or any document created with the expectation that the document may be used as evidence at trial, or any suitable combination thereof.

In accordance with at least one embodiment of the invention, a proactive method is enabled for notifying legally interested parties as to when electronic evidentiary documentation regarding the interest is available for access. Examples of legally interested parties include parties with respect to insurance claims such as automobile, property or casualty claims. For example, electronic evidentiary documentation may become available when generated and/or released for access by a law enforcement agent or agency. An identified interested party may be notified, in almost real-time, of a potential liability or a loss relating to an incident and/or accident, for example, an incident and/or accident that includes law enforcement or emergency agency involvement. To enable such notification, for example, prior to the occurrence of such an incident, a person may visit a web site designed to be used as a graphical user interface for a secure evidence sharing system.

In accordance with at least one embodiment, the legally interested party (i.e. a private party, an insurance agency, an eyewitness, a government agency, etc.) may register with the secure evidence sharing system. Registration may include an acceptance of terms and conditions and/or a possible fee payment. The registration may occur before or after the incident involving law enforcement. Once registered, the legally interested party may be enabled to receive notifications when future incidents transpire and/or the party may receive notifications for past events for which evidence is available.

In accordance with at least one embodiment, evidentiary documentation is created during or after the incident. The evidentiary documentation is uploaded, either immediately or at a later time, to the secure evidence sharing system via the web site designed to be used as the graphical user interface for the secure evidence sharing system. Upon receipt of the evidentiary documentation, the system may seek out other interested parties based at least in part on evidentiary documentation, registration information, and data collected from external databases. The external databases may include various databases regarding, for instance, the department of motor vehicles, property taxes, or other government agency, to name a few. Interested parties identified may be notified electronically as to the availability of the evidentiary documentation.

In accordance with at least one embodiment, a party may be notified of the availability of evidentiary documentation via text, email, phone messaging, fax, or other means. The party may then choose to access the web site designed to be used as the graphical user interface for the secure evidence sharing system. If the party is not a registered, the system may prompt the party to register. The system may also require the party to pay a fee to obtain access to the evidentiary documentation. Once any applicable fee is submitted, the party may then be allowed access to the evidentiary documentation.

Though a registration process is provided as an example, it should be understood that formal registration is an optional process. In accordance with at least one embodiment, the legally interested party may decide they would rather not register their information and/or the evidence access process may be configured to optimize (e.g., minimize) a data input by the legally interested party. Instead of registration, or in addition to the registration process, the legally interested party may choose to submit an evidence request. During the evidence request process or at some other time, the originally interested party may indicate one or more additional parties for which notifications should be sent, thereby creating an evidence request on behalf of the additional parties. The system 114 may generate, for each corresponding evidence request, an open records request that the system 114 may then send to a law enforcement agency to be processed. An open records request may be a letter, an email or a fax that complies with open records legislation for the appropriate/selected agency in the appropriate/selected jurisdiction. Some time later, the law enforcement agency may choose to fulfill the open records request by uploading the requested evidentiary documentation. At such time, the original party and any additional parties indicated by the original party may receive notification from the system 114 that the documentation is available. Any subsequent uploads of evidentiary documentation, for example, by the law enforcement agency, may cause subsequent corresponding notifications to be sent by the system 114 to the previously notified party or parties.

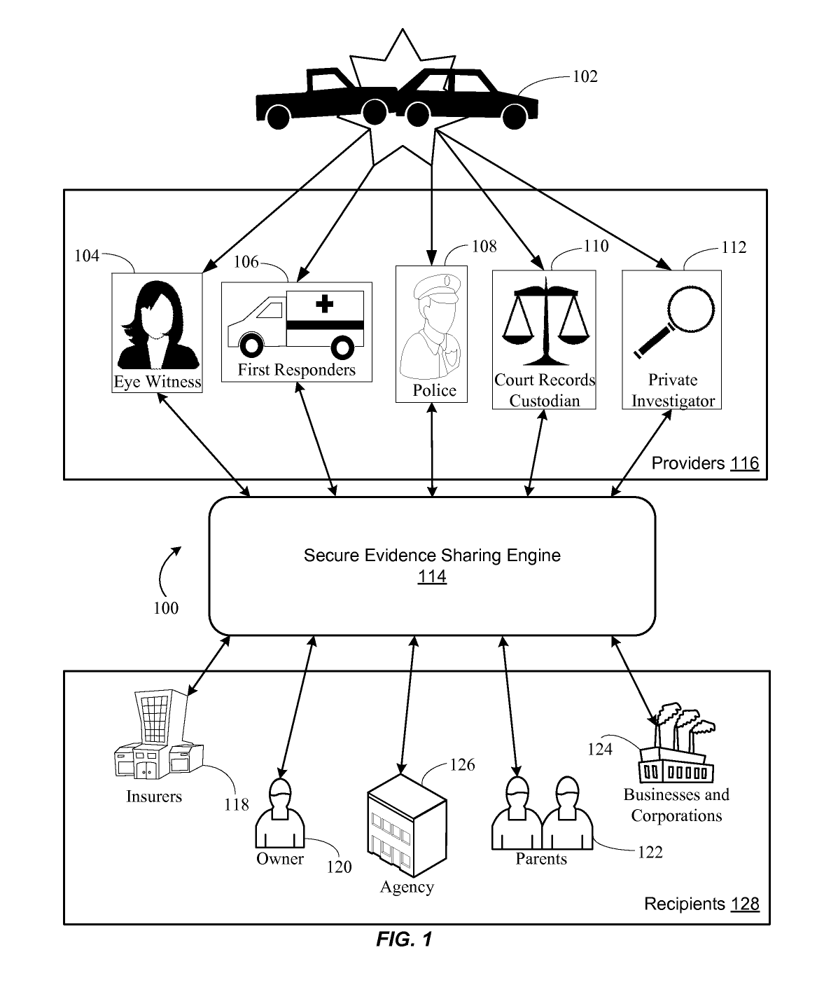

Referring now to the drawings, in which like reference numerals represent like parts, FIG. 1 illustrates an example secure evidence sharing environment 100 in which various embodiments can be implemented. Consider the situation in which an incident 102 occurs, which entails, at some point, involvement or assistance by law enforcement. For example, the incident 102 may be a car accident. Other such incidents may include a vandalism, a theft, an assault, a break down on the side of the road, a crime, a violation of a law or regulation, an arrest, or any other suitable event in which a law enforcement officer or agent is involved, for example, dispatched to the scene of the event. In such a situation, an eyewitness 104 may wish to issue a statement to a law enforcement agent 108 as to his or her observations of the event. Additionally, one or more first responders 106 responding to the accident may, in the course of their involvement, produce documentation of their efforts. Additionally, one or more law enforcement agents 108 responding to the incident 102 may produce, for example, a police report which may contain information pertaining to the officer's observation of the scene, general information of the parties involved, as well as statements from those involved and/or statements of witnesses. As a result of the incident 102, through possible initiated court proceedings, a court records custodian 110 may be in possession of court documents that others may wish to procure. Additionally, a private investigator 112, in the course of investigating the accident may produce documentation or his or her findings. The eyewitness 104, first responder 106, police officer 108, court records custodian 110, and private investigator 112, may choose to utilize a secure evidence sharing engine 114 for the purpose of disseminating evidentiary documentation to a legally interested party. Hereafter, these parties will be referred to as providers 116, in that they are in possession of evidentiary information or documentation that may be provided to the secure evidence sharing engine 114 for later dissemination.

A legally interested party is one that has a legal interest in, for example, a vehicle involved in the accident or possibly a court proceeding arising from the accident. In the example illustrated in FIG. 1, legally interested parties include one or more insurers 118, a person with ownership interest in one of the vehicles (hereafter referred to as an owner) 120, the parents 122, for example, of an underage driver involved in the accident, businesses and corporations 124 having an interest in one or more vehicles involved in the accident, and other agencies 126. Each interested party may choose to utilize the web site designed to be the graphical user interface for the secure evidence sharing engine 114. By entering identification information via the web site, the party may “register” with the service. Registration may include submitting information including, but not limited to, a legal given and surname, birthdate, home address, information pertaining to property owned and/or insured by the party, and identification numbers corresponding to one or more legal proceedings. Instead of, or in addition to registration, a party may choose to submit an evidence request. For example, the evidence request may include an incident date, an incident identifier such as a serial number assigned by a law enforcement agency, a first and last name of the requesting party, and a formal declaration that the requesting party has a legal right to view documentation related to the identified incident. Once registration occurs, or an evidence request submitted, the interested party may be considered a “recipient” 128 such that they, through registration or evidence request, have indicated that they wish to be notified by the secure evidence sharing engine 114 when evidentiary documentation regarding, in this example, the car accident, becomes available for access.

A provider 116 may then choose to utilize the web site designed to be the graphical user interface for the secure evidence sharing engine 114 to register, in a similar manner described above, as a provider. During registration the provider 116 may be prompted about issues such as how long the provider 116 would like to contract with the system or share revenue. Example types of contract may include a fee sharing percentage plan, a bulk order discounted plan, a flat fee plan requiring a payment to the system for each document shared, though it should be understood that multiple other payment plans may be utilized. Under a fee sharing percentage plan, the evidence provider may agree to accept a percentage of a collected fee from a user and relinquish the remaining percentage to the secure evidence sharing system provider as payment for services. This type of fee structure may include the system provider collecting the fee first and remitting the appropriate percentage to the evidence provider in, for instance, monthly installments. A bulk order discounted plan may provide providers bigger revenue streams based on a consideration of the quantity of evidence documents uploaded by the provider and subsequently purchased by a recipient. A provider who qualifies for this plan by producing and selling documentation at higher quantities, the bulk order discounted plan may produce higher revenue streams for the provider. Additionally or alternatively, the provider may select a simple flat fee plan in which the provider remits to the system provider, a standard flat fee on a, for instance, per document basis.

In accordance with at least one embodiment, providers 116 may give the system the exclusive right to disseminate evidence for a certain length of time in exchange for increased revenue sharing. For instance, a three year agreement with providers could result in a higher share of revenue than a one year agreement. In accordance with at least one embodiment, the process of registering and selecting a fee agreement by a provider, for example a police department, would create a revenue stream for the department. Additionally, such actions would reduce the cost the department may currently incur from having to, for example, gather and store evidence via CD/DVD and mailing evidence to interested parties only after checks or money orders have been processed regarding the requests.

Once a provider 116 has registered with the secure evidence sharing engine 114 the provider 116 may upload evidentiary documentation. Upon receipt of the uploaded evidentiary documentation, the secure evidence sharing engine 114 may store the documentation in a data store used to store such information. Additionally, the secure evidence sharing engine 114 may identify legally interested parties. The secure evidence sharing engine 114 may further determine parties to notify based on the previous indication by a legally interested party, that an additional party should be notified. Once parties are determined and/or identified, the secure evidence sharing engine may then notify a potential recipient 128. This notification may come in multiple forms. For example, the notification could be achieved by, but is not limited to, text messaging, emailing, postal mail, automated phone messaging, or by a social networking status entry such as a “tweet” via Twitter®. The notification may include information indicating to the recipient that evidentiary documentation is available for their viewing. Once a recipient 128 has received notification that evidentiary documentation is available for viewing, they may choose to access the web site designed to be the graphical user interface for the secure evidence sharing engine 114 to pay for or obtain for free, the evidentiary documentation available.

In one example, an insurer 118 may choose to register with the secure evidence sharing engine 114 through the aforementioned registration process for recipients. The insurer 118 may include information for one or more assets that they insure. Examples of insured items include vehicles, houses, high value personal property, and mementos, to name a few. An authorized agent of the insurance company may accomplish such registration by visiting the web site designed to be used as the graphical user interface for a secure evidence sharing system. The authorized agent may then register with the web site by submitting user profile information as well as information pertaining to items and/or property that the insurance company insures. This registration may be completed prior to or following an incident involving insured property and law enforcement officers.

At some point in the future, the item may be involved in an incident involving law enforcement. A responding law enforcement officer, for example, may enter information pertaining to the incident 102 in a corresponding police report. The police report may include the officer's written observations at the scene, general information about the incident 102 and parties involved, and statements from witnesses and parties to the incident 102. Additionally, or alternatively, the information may include video and/or audio recordings recorded by an in-car camera, an officer worn camera, an audio recorder, a mobile device or any device capable of recording video and/or audio. The law enforcement agency, at some point, may upload the evidentiary documentation to the secure evidence sharing engine 114, at which point the insurer 118 may be notified. Upon notification, or by prior agreement to pay for certain documents automatically without further approval, the insurer 118 may obtain the evidentiary documentation for use in processing claims involving the incident 102. This particular utilization of the secure evidence sharing engine 114 may increase the insurer's 118 efficiency in processing claims and reduce the cost of investigating and litigating insurance claims.

In accordance with at least one embodiment, an owner 120 or parent 122 of an underage driver, or other private party may register as a recipient 128 with the secure evidence sharing engine 114 using the aforementioned registration process. In a similar manner as described above, were the registered item or driver involved in an incident involving law enforcement and evidentiary documentation uploaded by some provider, the owner 120 or parent 122 would be notified that the evidentiary documentation was available, for a fee, or alternatively, for no fee. The owner 120 or parent 122 or other private party would then be enabled to pay any fee attached to access of the documentation. After payment is processed by the secure evidence sharing engine 114, the owner 120 or parent 122 would then be able to access the evidentiary documentation. By utilizing such a method, the owner 120 or parent 122 would be able to access evidentiary documentation more quickly than if they were to follow a process in which they submit a written request accompanied with a check or money order to the law enforcement agency. Additionally, online payment may afford the owner 120 or parent 122 a more convenient method of payment than providing a check or money order.

In accordance with at least one embodiment, the owner 120 may submit an evidence request. The evidence request may include information such as: an incident identifier such as a serial number, an incident date, a first and last name of the owner, and an email address of the owner. Additionally, the owner may indicate additional parties to be notified, for instance, the owner's attorney. In a similar manner as described above, when evidentiary documentation is uploaded, the owner and any additional parties indicated by the owner, here, the attorney, may be notified that the documentation is available. The owner or additional party may then remit payment and access the documentation in a similar manner as described above.

In accordance with at least one embodiment, a law enforcement agency may wish to share documentation with another agency 126. In this example, the law enforcement agency may register with the secure evidence sharing engine 114 as a provider 116. The corresponding receiving agency 126 may register with the secure evidence sharing engine 114 as a receiver 128. In a similar manner as described above, when the law enforcement agency uploads evidentiary documentation, the receiving agency 126 may be notified as to the availability of such documents. The receiving agency 126 would then be enabled to access the evidentiary documentation, possibly after remittance of a fee. Through this process, the sharing of evidentiary documentation between agencies may be made more efficient and convenient for both agencies concerned.

In accordance with at least one embodiment, an eyewitness 104 to an incident involving law enforcement may wish to share a statement including details of his or her observation of the incident 102. The eyewitness 104 may register as a provider of evidentiary documentation through the web site designed to be the graphical user interface for the secure evidence sharing engine 114 in a similar manner as described above. During registration, the eyewitness 104 may choose to provide contact information or not. Additionally, the law enforcement agency may previously have registered as a recipient of such information. When the eyewitness 104 uploads an eyewitness statement, the law enforcement agency may be notified, in a similar manner as described above, of the availability of the statement. The law enforcement agency may then choose to access the statement to ascertain the information contained therein. The utilization of the secure evidence sharing engine 114 for the purpose of sharing eyewitness statements may be beneficial in providing a more convenient method for an eyewitness 104 to share information with law enforcement. Additionally, given that the statement may be submitted anonymously, utilization of the secure evidence sharing engine 114 may encourage more eyewitnesses 104 to submit information without the apprehension of exposing their identities.

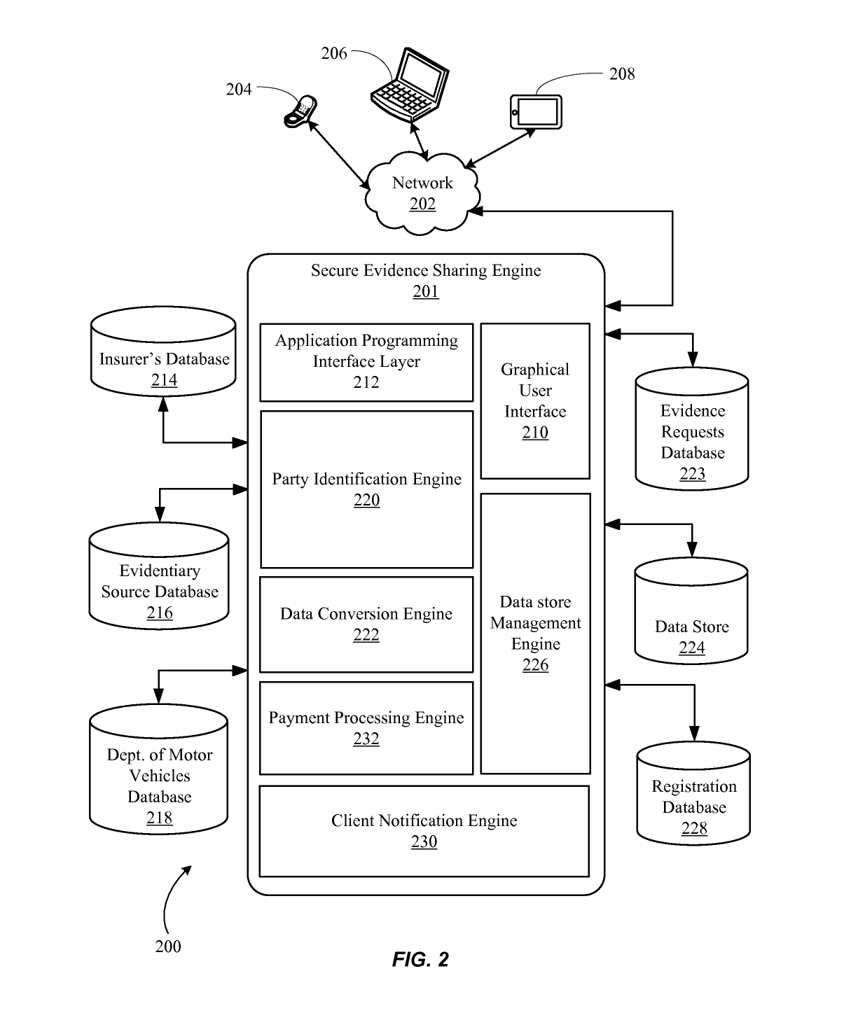

FIG. 2 illustrates an example architecture 200 for a secure evidence sharing engine 201 in accordance with various embodiments. The secure evidence sharing engine 201 is an example of the secure evidence sharing engine 114 of FIG. 1. Communication between mobile devices and the secure evidence sharing engine 201, in most embodiments, utilizes at least one network 202 that would be familiar to those skilled in the art for supporting communications using any of a variety of commercially-available protocols, such as TCP/IP, OSI, FTP, UPnP, NFS, CIFS, and AppleTalk. The network 202 can be, for example, a local area network, a wide-area network, a virtual private network, the Internet, an intranet, an extranet, a public switched telephone network, an infrared network, a wireless network, and any combination thereof. A device capable of communicating with the secure evidence sharing engine may include a cell phone 204, laptop computer, 206, tablet computer 208, personal computer or any device capable of sending and receiving message over a network.

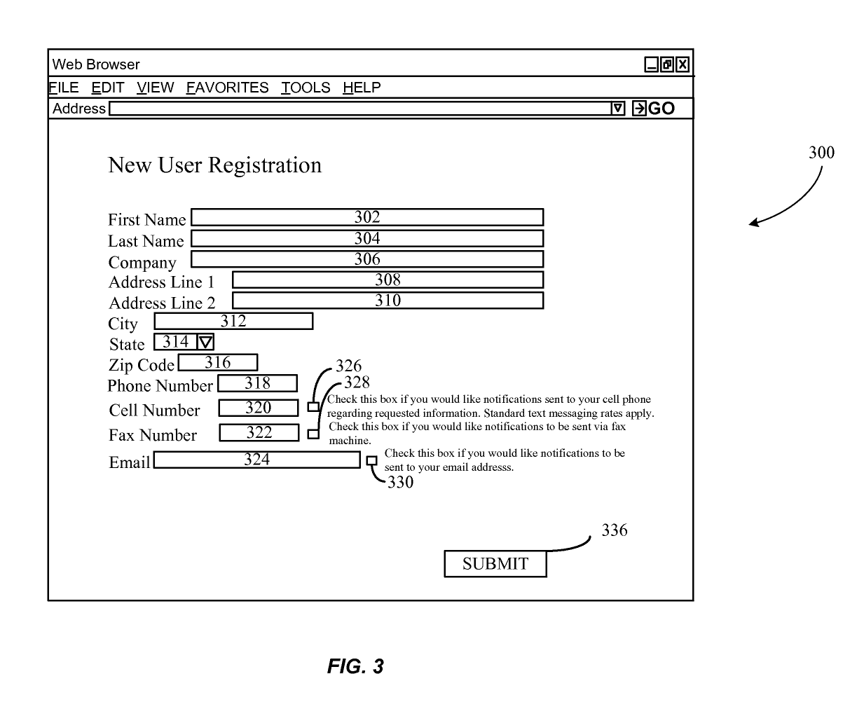

In one example, the secure evidence sharing engine 201 contains a graphical user interface 210. The graphical user interface 210 may, in accordance with at least one embodiment, be the web site designed to collect data from a user and communicate that data to the secure evidence sharing engine 201. Example details of the graphical user interface 210 are described below in more detail with reference to FIGS. 3-10. In accordance with at least one embodiment, registration information or evidence request information is gathered through utilizing the graphical user interface 210. This registration information may include, but is not limited to, names, contact information, and personal and real property descriptions and identifiers. The evidence request information may include, but is not limited to, names, contact information, incident dates and incident identifiers. During the evidence request process or at some other time, the originally user may indicate one or more additional parties for which notifications should be sent, thereby creating an evidence request on behalf of the additional parties. Though discussed above in an evidence request context, the ability for a user to indicate one or more additional parties to be notified may occur in any suitable context including any suitable point of interaction with the user such as interaction with the graphical user interface 210. Once obtained, the registration and/or evidence request information may be sent to the database management engine 226, responsible for storage management in various data stores utilized by the secure evidence sharing engine 201 to store a variety of data, including, but not limited, received evidentiary data, registration information, and evidence request information. The database management engine 226 may then store the registration and/or evidence request information in a data store 228 associated with storage of such information.

In accordance with at least one embodiment, the secure evidence sharing engine 201, contains an application programming interface 212. The application programming interface 212 may receive requests from the graphical user interface 210 and, based on those requests, may make calls to the secure evidence sharing engine 201. In accordance with at least one embodiment, the application programming interface 212 may also contain multiple interface components that corresponds to interfaces that are shared between the application programming interface 212, and an external source data store. For example, the application programming interface 212 may contain an interface responsible for communication between the secure evidence sharing engine 201 and an insurer's internal database 214 responsible for storing, at least, information regarding the insurer's clientele and insured vehicles. In accordance with at least one embodiment, the application programming interface may include an interface responsible for communication between the secure evidence sharing engine 201 and evidentiary source database 216, for instance, a law enforcement internal database used for storing audio, video, and digital evidentiary documentation. In accordance with at least one embodiment, the application programming interface 212 may contain an interface responsible for communication between the secure evidence sharing engine 201 and the department of motor vehicles database 218, for instance, used for storing electronic documentation of licensed driver and vehicle information. Though only three databases are shown to interact with the application programming interface 212 of the secure evidence sharing engine 201, it should be understood that any number of evidentiary documentation source data stores may interact in a similar manner with the application programming interface 212 and that the illustration is not meant to limit the invention. Additionally, evidentiary documentation source data stores may include more than what is shown in this illustration, any combination of which may be used in an embodiment.

In accordance with at least one embodiment, the secure evidence sharing engine 201 may contain a party identification engine 220 that may be responsible for identifying providers of requested evidentiary documentation and/or identifying legally interested parties upon receipt of evidentiary documentation. The party identification engine 220 is an example of a party identification component. For example, the party identification engine 220 may parse received requests for evidentiary documentation to identify one or more types of requested evidentiary documentation and then identifying one or more corresponding providers of the requested evidentiary documentation based at least in part on the identified one or more types of the requested evidentiary documentation. The party identification engine 220 may utilize any suitable information related to requested evidentiary documentation to identify corresponding providers including a related legal jurisdiction and/or geographic location. As another example, upon receipt of evidentiary documentation, the party identification engine 220 may parse the identification information from the evidentiary documentation and create a tuple of multiple identifiers to be used later for lookup of documents pertaining to a particular person or object. The multiple identifiers correspond to identifiers associated with a person or object. Once the tuple has been created, the party identification engine 220 may pass the data conversion engine 222. Additionally, the party identification engine 220 may store contact information associated with additional parties to be notified, for example, as indicated by a submitted evidence request, in an evidence request data store 223. Identifying information associated with the additional parties may be at least, a request identifier, incident identifier, relationship to original party, and email address, to name a few. A set of interested parties, or the like, is identified for each incident of evidentiary documentation. Uploads of related information, in any suitable context, can trigger notifications to the identified set of interested parties.

The data conversion engine 222 may be responsible for converting any source document format into an appropriate normalized format (e.g., suitable for storage in a relational database management system and/or such that the document attributes may be queried with a structured query language) to be stored a data store 224, the data store 224 associated with storage of such received information. The normalized format may be normalized in the relational database sense of normalization to minimize data redundancy and avoid data anomalies, such as update anomalies. One consequence of such normalization may be that business records (such as a purchase order, an insurance claim, a financial transaction, etc.) are split into pieces that are scattered over potentially many relational tables. Alternatively, or in addition, normalized formats may correspond to standardized format choices for various disparate “raw” electronic evidentiary document formats including standardized format choices for audio, video, and the like. Once the evidentiary documentation is converted into the appropriate format for storage, the data conversion engine 222 may pass the documentation on the database management engine 226 which may be responsible for the storage of such data in the general data store 224.

The secure evidence sharing engine 201 may further include a client notification engine 230 configured at least to interact with various notification services to provide notifications of evidence sharing events to interested clients including evidence providers and requesters. For example, responsive to a request for evidentiary documentation, the client notification engine 230 may notify one or more providers of the requested evidentiary document with respect to corresponding open records requests. The client notification engine 230 may be configured to send one or more reminders and/or re-notifications when one or more corresponding time periods pass without the secure evidence sharing engine 201 receiving a suitable response to provided notifications. As another example, once the evidentiary documentation has been received, processed, and subsequently stored in data store 224, the client notification engine 230 may be utilized. The client notification engine 230 may be responsible for electronically notifying clients and/or potential clients that evidentiary documentation is available for their access. The client notification engine may interact with the party identification engine 220 to determine parties who may have a legal interest in the object or outcome of the received evidentiary documentation, or parties who may have been identified by a legally interested party as an additional party to be notified. Once one or more parties have been identified, the client notification engine 230 may cause at least one of a text, an email, an automated phone message, or other suitable notification method, to be provided to each identified party including at least the information of what evidentiary documentation was available and a fee, if applicable, that the party might pay for access to such information.

A party, having received the notification, may then choose to access the web site designed to be used as the graphical user interface 210 for the secure evidence sharing engine 201, in order to enter in their payment information. The user information may be passed to the party identification engine 220 to verify that the user has a legal right to access the evidentiary documentation. The determination of whether the user has a legal right to view the document may be determined, for example, by comparing the user's identification information contained in the registration record to the information from the received evidentiary documentation and/or the identification information received from external databases. If the user's registration information matches the received information contained in the evidentiary documentation and/or the identification information, the identity of the user may be verified and the user may be determined to have a legal right to view the received evidentiary documentation. To match, the data need not be an exact match, for example, it can also be a partial match, or a search-like match, for example, that uses a confidence score and/or threshold. In accordance with at least one embodiment, the user may choose to indicate that they are a certain type of interested party, for instance, the driver, the attorney of the driver, the insurance agent of the driver, etc. If the user has made such an indication, the secure evidence sharing engine 114 may choose to take the indication as verification of a legal right and conduct no further verification. If the user has a legal right to view the evidentiary documentation, the payment information may then be process by a payment processing engine 232. Once payment has been made, the payment processing engine 232 may cause the database management engine 226 to retrieve the evidentiary documentation from the general data store 224. Such a process would allow for the interested party to access the evidentiary documentation paid for.

FIG. 3 illustrates an example of a graphical user interface 300 that is configured to collect new user registration information. It should be understood that this example is illustrative in nature and is not meant to limit the invention. In one example, a user who wishes to register with the secure evidence sharing engine 301 might navigate via an internet browser to a web site similar to the one depicted in FIG. 3. The secure evidence sharing engine 301 is an example of the secure evidence sharing engine 114 of FIG. 1. The user may then enter in registration information which may include a first name 302, a last name 304, a company associated with 306, a first line of their contact address 308, a possible second line of their contact address 310, a city corresponding to the contact address 312, a state 314, a zip code 316, a phone number 318, a cell number 320, a fax number 322, an email address 324, or a combination thereof. A profile may be created and a password may be established for secure access.

In accordance with at least one embodiment, the user may check a box 326 on the web site to indicate that the user would like to receive notifications via the cell phone number regarding requested information. In one example, the web site may contain a box 328 for the user to indicate that they wish to receive notifications via fax. In accordance with at least one embodiment, the web site may contain a box 330 that the user may utilize to indicate that the user wishes to receive notification via email of evidentiary documentation availability. Any combination of boxes 326, 328, 330 may be selected.

In accordance with at least one embodiment, the user may select the submit button 332 which may cause the secure evidence sharing engine 301 to verify the data contained in fields 302-330. If characters are included where they are not allowed, or information contained in one or more fields is disallowed, the user may be prompted to reenter their information. If the data conforms to the proper formatting requirements, the users data may be stored in the registration data store for later use and the user may be logged onto the system. In accordance with at least one embodiment, new recipients may have to agree to terms and conditions and complete the registration process before they may access evidence shared with them.

In accordance with at least one embodiment, users may manually enter the policy numbers, VIN numbers, names of insured drivers, business addresses, rental property addresses, etc. and register property or vehicles under their charge. In accordance with at least one embodiment, post registration and entry of property identifiers, UPC and/or Quick Response decals can be created by the system for each piece of property registered and can be placed on the property by the registered user. The UPC and/or Quick Response may be read by a scanner, smart phone, or other mobile device capable of sending and receiving message over a network and equipped with the system application/reader used by law enforcement or emergency personnel.

In accordance with at least one embodiment, once the user has completed the registration process but prior to entering property information, the secure evidence sharing engine 114 may automatically search for property for which the user may have legal interest. The system may accomplish this search via an interface with insurance claims software used by insurance companies/agents, bar code information currently in use on vehicles, driver licenses, license plate numbers, vehicle registrations, insurance cards, and interfaces with the state motor vehicle and property tax databases. If the user is identified through this process as an interested party in a particular piece of property, then the secure evidence sharing engine 114 may prompt the user to accept/reject addition of the property to the list of property for which the user wishes to receive notifications.

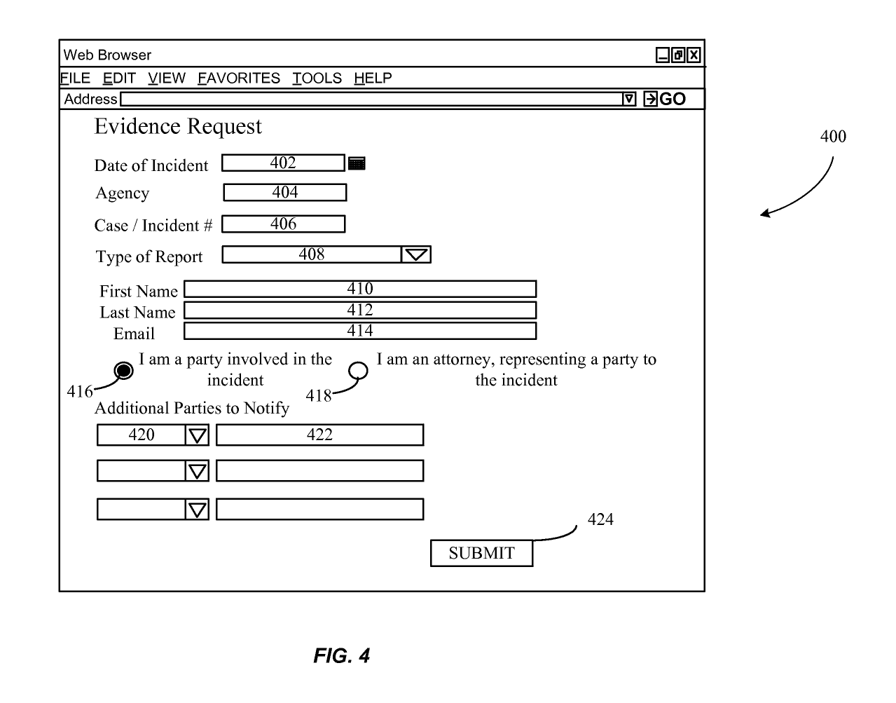

FIG. 4 illustrates an example of a graphical user interface 400 that is configured to allow a user to submit an evidence request. It should be understood that this example is illustrative in nature and is not meant to limit the invention. In one example, a user, may navigate via an internet browser to a web site similar to the one depicted in FIG. 4. The user may then select an incident date 402, a law enforcement agency 404, and a case or incident number 406. From a drop down menu 408, the user may select at least one type of report the user may be interested in receiving. The type of reports may include, but are not limited to, police reports, photographs, audio statements, in-car and on-person video. The user may then enter their first name 410, last name 412 and email address 414. The user may then indicate what type of user they are, for instance, a party involved in the incident 416, or an attorney representing a party to the incident 416. The selections available for type of user may correspond to permitted requestors as defined by appropriate open records legislation. Consider the situation in which the user selects to indicate that they are a party involved in the incident by selecting button 418, the user may then select other parties to notify. The user might select the relationship of the additional party by selecting an option from a drop down menu 420. Additionally, the user may enter in the additional party's email address in box 422. Once the user selects the submit button 424, the information entered may be processed by the system and an open records request may be generated and submitted to the indicated law enforcement agency 404. In accordance with at least one embodiment, submission of an evidence request may generate a legally compliant open records request that is automatically transmitted to the law enforcement agency.

Some time later, a law enforcement agency 404, upon receiving the open records request, may comply with the open records request and upload the electronic evidentiary documentation to the system 114. Once evidentiary documentation is received by the system 114, notifications may be sent to the original user indicated in 410, 412 and 414, as well as the additional party indicated in box 422. Each user, upon receipt of the notification, may navigate to the web site designed to be used as the graphical user interface for the system, to possibly remit payment and access the evidentiary documentation. In accordance with at least one embodiment, some time later (e.g., hours, days, months and more), the law enforcement agency 404 may upload additional evidentiary documentation, at which time, the original user indicated in 410, 412 and 414, as well as the additional party indicated in box 422, as well as any users having related evidence requests (e.g., related by incident number 406), currently, or in the past, may receive notification of the availability of the further evidentiary documentation. It should be understood, that the law enforcement agency may comply with the open records request in any manner they desire (e.g. paper documents, electronic, CD-ROM, etc.). In accordance with at least one embodiment, the law enforcement agency need not be the agency that uploads the evidentiary documents, for example, an administrator of the secure evidence sharing engine 201 may prepare and upload the evidentiary documentation into the system 114.

The open records request sent to the law enforcement agency 404 may be associated with one or more time periods within which a response to the open records request is expected and/or required. For example, the one or more time periods may be specified in an open records law that governs the open records request. Such time periods may include a time period for acknowledging receipt of the open records request and a time period for fulfilling the open records request (e.g., providing the requested records to the requestor). The system 114 may resend the open records request, or a notification, such as a reminder, referring to the open records request, to the law enforcement agency 404 periodically until an appropriate response to the open records request is received. These notifications or retransmitted open records requests may indicate specific mandated open record deadlines, for example, as determined by open records legislation associated with the providing agency.

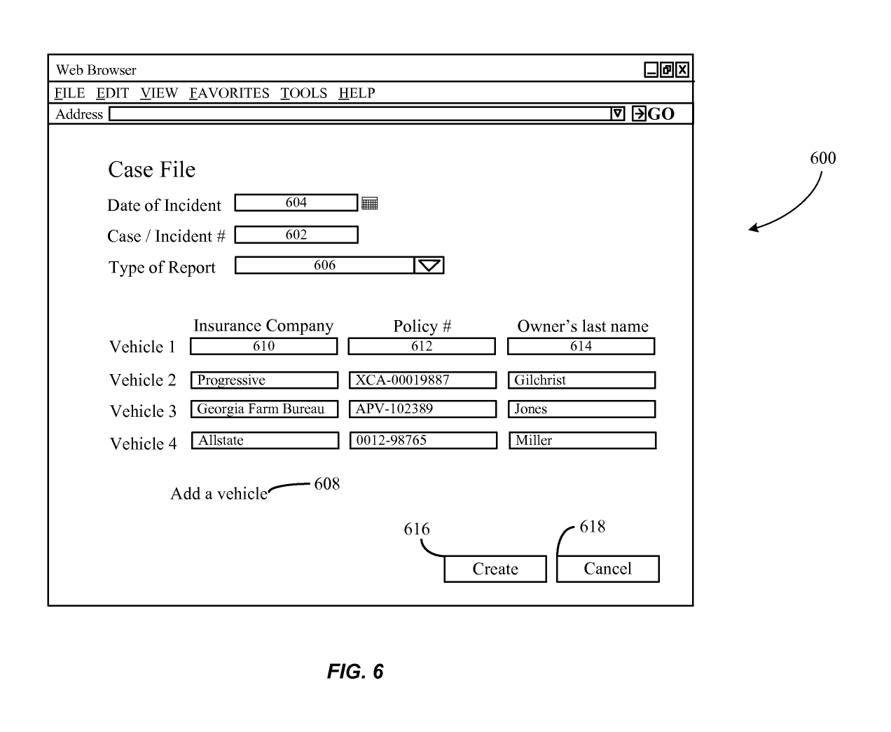

In accordance with at least one embodiment, the user, in a manner similar to that described above, may request evidence that may be under the control of multiple providers. In one example, the system 114 may parse the evidence request and generate multiple open records requests, each such open records request corresponding to a particular provider of the requested evidentiary documentation. For instance, if the user requested both an accident report and a 911 recording via box 408, the system 114 may parse the resulting evidence request and generate an open records request for each of the accident report and the 911 recording. An open records request, customized for each custodian/provider, may be then sent by the system 114. If a case file corresponding to the incident has not been created by the provider, the submission of the evidence report may create such a case file. The case file, for which example details are described below with reference to FIG. 6, may be a receptacle, such as a data object, for evidence documentation pertaining to a particular incident. Each custodian/provider, upon receipt of the open records request may choose to fulfill the request in any suitable manner, as discussed above, by uploading evidentiary documentation to the case file or providing the documentation for others to upload to the case file. Through this process, the amount of superfluous notifications to providers may be reduced, for example, providers may receive fewer notifications pertaining to evidence not under the provider's control.

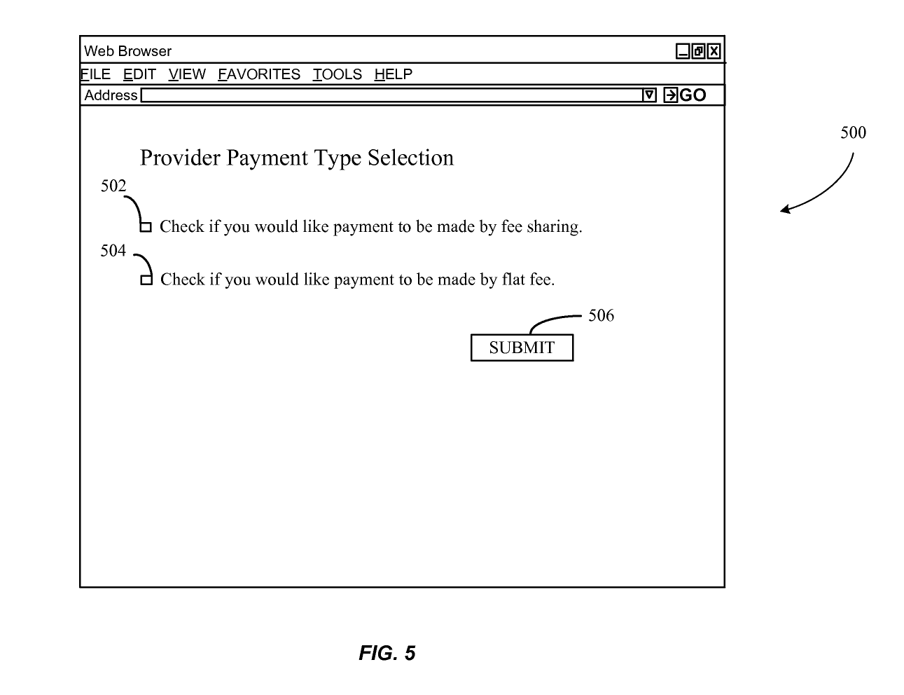

FIG. 5 illustrates an example of a graphical user interface 500 that is configured to collect an indication of a provider payment type selection. It should be understood that this example is illustrative in nature and is not meant to limit the invention. In one example, a registered provider who wishes to upload data to the secure evidence sharing engine 114 may navigate via an internet browser to a web site similar to the one depicted in FIG. 5. The user would then enter a selection as to what type of payment plan the user would like to enroll under. In this example, the figure depicts only a fee sharing and flat fee option. It should be understood that various plans may be presented to the user and the two displayed here are merely for illustrative purposes. To select a fee sharing plan, the user may select the box labeled 502. To select a flat fee plan, the user may select the box labeled 504. Once a selection is made the user may left click the submit button 506 which may send the indication of selection to the secure evidence sharing engine 114.

FIG. 6 illustrates an example of a graphical user interface 600 that is configured to allow a provider to create a new case file. In accordance with at least one embodiment, a case file may be identified by a case/incident number 602 and may contain one or more evidentiary documents. The provider may include the date of the incident 604 and the type of report 606. Utilizing this, or a similar, web site, the provider may enter in party identification information. For instance, the provider may select the “add a vehicle” link 608. By selecting this hyperlink, the web page is refreshed to include new boxes labeled 610, 612 and 614. Information typed in box 610 may correspond to, for example, an insurance company (i.e. State Farm). Information in box 612 may correspond to a policy number (i.e. 01-2345678-0). Information contained in box 614 may include the Owner's last name (i.e. Davis). The provider may select the “add a vehicle” hyperlink 608 multiple times corresponding to each vehicle involved in, for example, a multiple car accident. Once the party identification information is determined, the provider may select the “create” button 616 to submit the data to the secure evidence sharing engine 114. The user may also select “cancel” 618 to cancel their request to create a new case file. Once a request is received, the secure evidence sharing engine 114 may create a case file containing the data indicated by the provider. The system includes data storage for the case files. The case file is organized according to the aforementioned information (i.e. report number, date of incident, insurance company name, policy number, address, involved parties, property owners, etc.). This storage may occur through a relational database or through SQL storage, as examples.

In accordance with at least one embodiment, this information can also be automatically entered into the system through a single entry interface with police report generating software, a smart phone/portable device, or at the scene of the incident 102 through the system generated UPC/Quick Response (QR) Code, placed on the property which has been created by the system, or is present on the driver licenses, vehicle registration, vehicles and/or insurance cards, etc. In accordance with at least one embodiment, a responding law enforcement officer may simply write the information down in the police report for later inclusion in the police record. Later, the report may be processed by record management personnel responsible for managing police records through the use of the web site designed to be used as the graphical user interface 210 for a secure evidence sharing engine 114.

Additionally, or alternatively, the law enforcement officer may utilize a mobile device capable of scanning in UPC and/or Quick Response codes. The law enforcement officer may choose to scan these codes present on driver licenses, vehicle registrations, insurance cards, and codes previously printed out and placed on the property (e.g. the vehicle). UPC and/or Quick Response code scans may then be transmitted to the secure evidence sharing engine via the mobile device. In this way, the scanning of the UPC and/or Quick Response codes may produce a much faster result than if the entry of the data was accomplished by record management personnel.

In accordance with at least one embodiment, once the case file is established, individual pieces of evidence may be uploaded into the case file by the provider, or a checklist of evidence currently available, or expected to be available in the future may be established. A default list of customarily available evidence can also be generated by the system in lieu of a specific list of evidence. The list of available or potentially available evidence can then be shared by the system with recipients so they can decide which evidence they would like providers to upload. Providers may choose to refrain from uploading certain evidence unless ordered by a recipient in advance a revenue stream is generated.

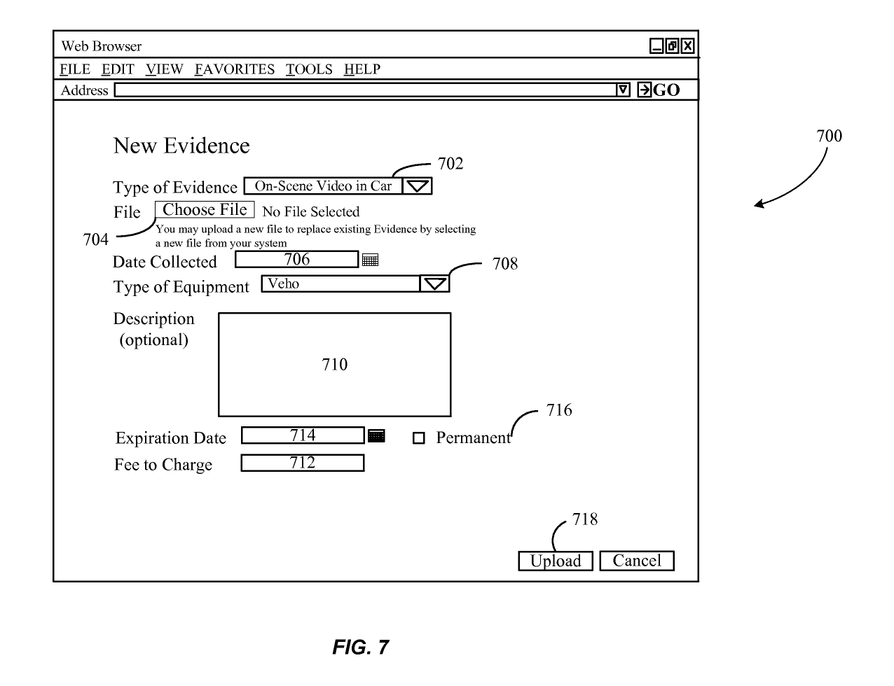

FIG. 7 illustrates an example of a graphical user interface 700 that is configured to allow a provider to upload new evidence. In one example, a registered provider who wishes to upload data to the secure evidence sharing engine 112 may navigate via an internet browser to a web site similar to the one depicted in FIG. 7. The provider may enter a selection of a type of evidence document via a drop down menu 702, i.e. report, video, audio, photograph, etc. Depending on the device used, the evidence may automatically be identified based on file format, size, etc. In one example, the provider may then select a file by clicking a “choose file” button 704 to locate on the provider's computer or external device the file the provider wishes to upload. The provider is prompted to divulge the date the evidence was obtained 706. For instance a video from an accident scene may be taken on the day of the accident, but video/audio interviews with witnesses may be obtained days later. In one example, the provider may be prompted to choose the type of equipment used to gather the evidence from a drop down menu 708. The secure evidence sharing engine may convert the evidence to a compatible medium when necessary. In accordance with at least one embodiment, the provider may enter a text description of the evidence 710.

In accordance with at least one embodiment, the provider establishes a fee for the evidence 712, or the secure evidence sharing engine uses the pre-established default fees for particular evidence. Some evidence can be shared with other law enforcement agencies, court systems, etc. without the system or recipient charging fees. The provider may also, for example, establish an expiration date 714 for the evidence, usually in accordance with the statute of limitations for holding the particular type of evidence. A default expiration date 714 can be provided by the system. If the provider selects an expiration date 714, the system may delete the documentation upon the day of expiration. Evidence marked permanent 716 by the provider may carry an additional fee payable to the system and deducted from the provider's proceeds. The provider may then choose “Upload” 718 and the evidence is uploaded into the previously created case file.

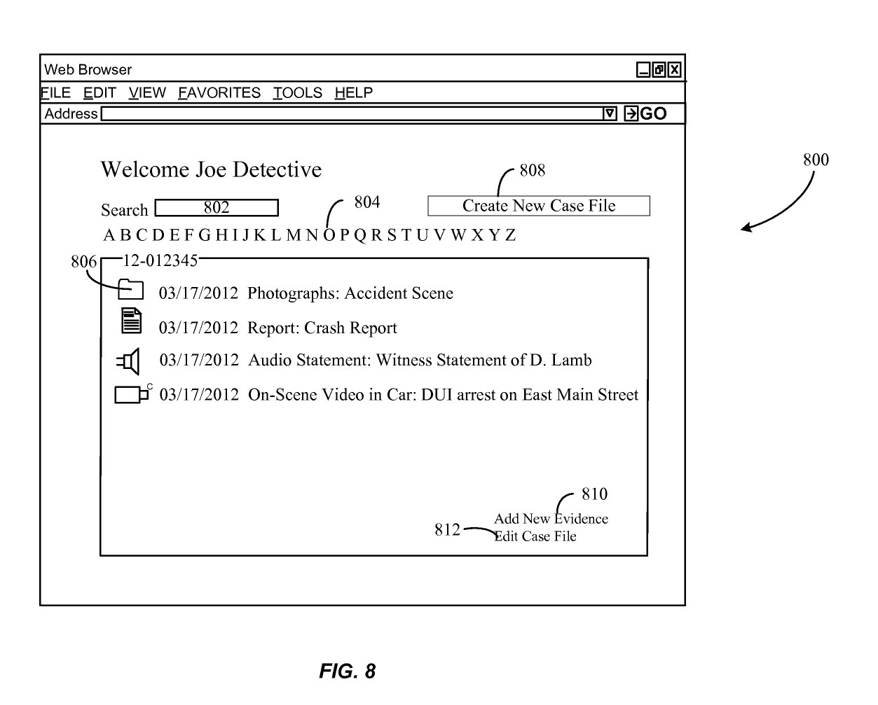

FIG. 8 illustrates an example of a graphical user interface 800 that is configured to allow a provider to view the evidentiary document contained in a case file. In one example, once a provider has uploaded at least one evidentiary document, the one or more documents may be listed in a manner similar to the depiction of FIG. 8. A search bar 802 may be provider to allow for a provider to type in a search word to search for within the case file. Additionally, the provider may choose to utilize a series of hyperlinks 804 corresponding to letters of the alphabet. Upon clicking on a particular letter, the provider may be shown case files that start with the letter selected. In one example, icons 806 corresponding to the particular type of evidence document may be displayed adjacent to the file name to allow the provider to quickly identify, at a glance, the type of document. The provider may select the “Create New Case File” button 808 to create a new case file in FIG. 6. The provider may also select “Add New Evidence” 810 to add new evidence as described in FIG. 7. The provider may also choose to select “Edit Case File” 812 to edit a previously created case file. This would allow the provider to add or delete files in a previously created case file. In one example, providers may also have access to an activity log to track the chain of custody for all evidence and to determine the most profitable and efficient means of notifying interested parties.

In accordance with at least one embodiment, once evidence has been uploaded and displayed in the case file as depicted in FIG. 8, recipients are automatically or manually notified by the system via email, fax, text, or alternative means that an accident/incident has occurred involving something the recipient has insured, or has claimed a legal interest. Social networking services, such as tweeting can be used to distribute information. For example, the system can utilize Twitter or a similar micro-blogging service to provide regular update regarding a file. For example State Farm, an insurance company, may have claim managers, agents, and/or small business owners who could elect to “follow” the system for accidents/incidents involving their vehicles, drivers, and/or policies. Included in the notification to recipients is a certification of authenticity automatically generated by the system on behalf of the provider. In accordance with at least one embodiment, notification affords recipients the option to purchase the individual evidence, view a preview of the evidence for a reduced fee, or purchase an entire case file, upon agreeing to additional terms and conditions pertaining to the evidence. Once the evidentiary documentation is purchased by the recipient, a link to a permanent file may be created or activated allowing access to the evidentiary documentation. Recipients may be notified of the expiration date established by the provider. The recipient may have the opportunity to re-establish an expiration date for the evidence in accordance with recipient standards.

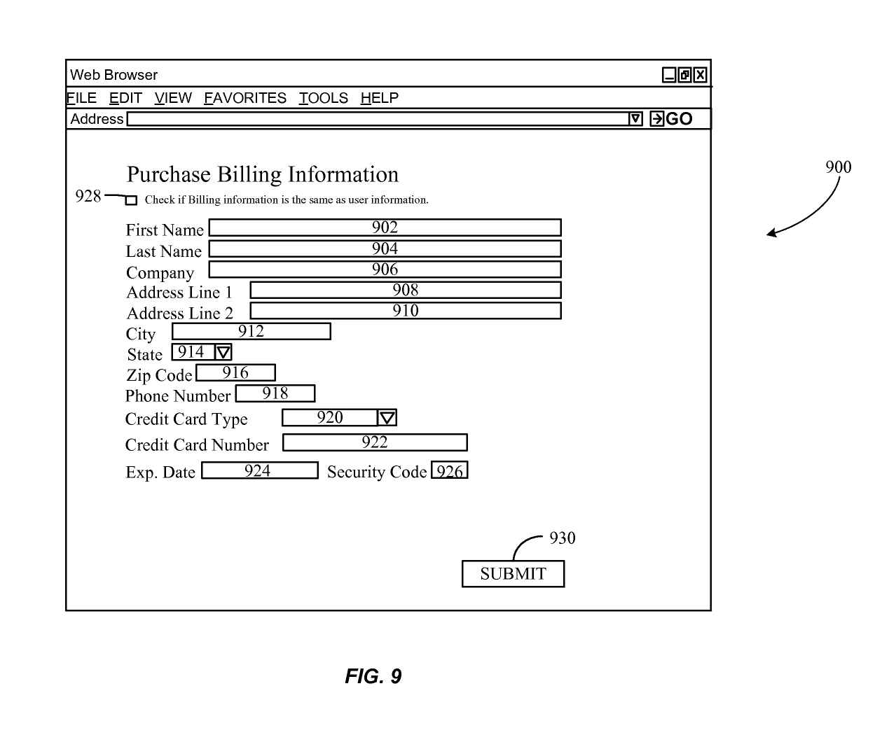

FIG. 9 illustrates an example of a graphical user interface 900 that is configured to allow a recipient to enter a payment method on the system. In accordance with at least one embodiment, the recipient may be prompted for this information during the registration process discussed in FIG. 3. Unregistered recipients, for example, fleet managers or insurance company representatives whose contact information has been obtained and registered in advance by the system, may be automatically contacted by the system after, for instance, an incident/accident is recorded. These recipients may be prompted to register a payment method on the system and go through the general registration process before being allowed to access the evidentiary documentation.

In accordance with at least one embodiment, a recipient would navigate to a web site similar to the one depicted in FIG. 9. The recipient may be prompted to fill out several fields including, but not limited to, a first name 902, a last name 904, a company 906, a first line of a contact physical address 908, a second line of a contact physical address 910, a city 912, a state 914, a zip code 916, a phone number 918, a credit card type 920, a credit card number 922, a credit card expiration date 924, and a security code located on the credit card 926. In one example, recipients who have already filled out similar information during the registration process, may select a box 928 which may automatically fill in the fields with the information previously entered in the system. The user may submit the information to the secure evidence sharing system 114 by selecting the submit button 930.

In accordance with at least one embodiment, following the billing method entry, recipients may be given the opportunity to provide a list of evidence for which they choose to pay without the need for specific approval. This may be especially beneficial for insurance companies registering as recipients if there are evidentiary documents that, as a procedural matter, the company consistently orders when processing insurance claims. For example, an insurance agency may have a standing order to pay for at least one accident or incident reports involving anything they insure. One benefit to such a feature may be to the provider as the selection of a recipient to pay for particular documents without further approval creates a guaranteed revenue stream. A second benefit may be to the recipient, for example an insurer, whose efficiency in processing a claim may be greatly increased due to the automation of requesting such evidentiary documentation.

In one example, following payment processing and acceptance, recipients may be able to share evidence for a fee charged to a new recipient if given an option to share evidence by the provider. This feature may be beneficial to a party who wishes to prompt another party to register with the secure evidence sharing engine 114 so that the parties may share the evidentiary documentation. The feature may be beneficial to the provider in respect to increased revenue such that the feature allows a self-registered party to self-identify more parties. These identified parties, previously unknown to the provider, may now also be afforded the opportunity to access evidentiary documentation, possibly for a fee. If the identified party wishes to access the evidentiary documentation, they would follow the aforementioned process, including eventual prompting of billing method entry as discussed above.

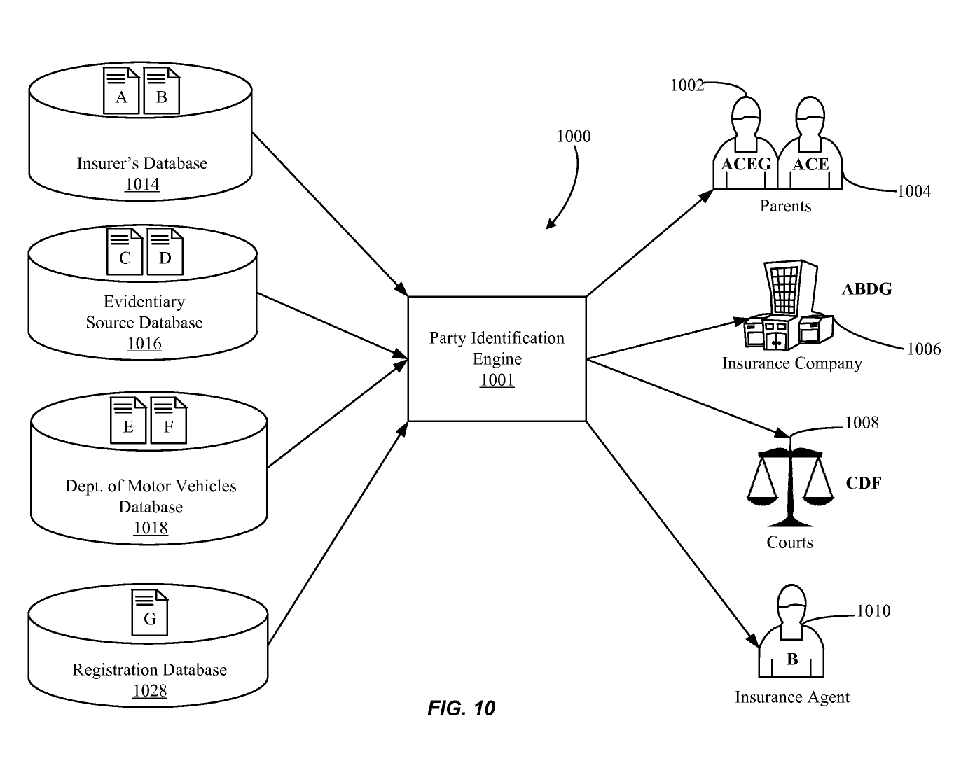

The system 200 need not rely on recipients to self-register. FIG. 10 illustrates an example environment 1000 in which data objects are gathered from multiple source data stores in accordance with various embodiments. The system 200 may continue to register and reach out to government entities, insurance companies, public and private database companies and other potential recipients to link searchable databases of property owners, insurers, claims and stakeholders to accidents and/or incidents. In one example, the party identification engine 1001 (e.g., corresponding to the party identification engine 220 of FIG. 2), may receive certain data objects A, B, C, D, E, F, and/or G from multiple source data stores. For example, documents A and B may reside in an insurer's database 914 (e.g., corresponding to the insurer's database 214 of FIG. 2). Documents C and D may be located in an evidentiary source database 916 (e.g., corresponding to the evidentiary source database 216 of FIG. 2), for instance a data store managed by a law enforcement agency. Documents E and F may reside in a department of motor vehicles database 918 (e.g., corresponding to the department of motor vehicles database 218 of FIG. 2). Additionally, document G may contain registration information stored in the registration database 928 (e.g., corresponding to the registration database 228 of FIG. 2), managed by the database management engine component 228 of the secure evidence sharing engine 201.

Consider the situation in which one parent 1002 and an insurance company 1006 each register separately by the aforementioned process. The parent's information as well as the insurance company's information may reside in document G, stored in the registration database 228 managed by the database management engine 226, a component of the secure evidence sharing engine 114. Upon receiving evidentiary documentation pertaining to registered property, for instance a vehicle, the parent 1002 and insurance agency 1006 would automatically be notified by the aforementioned process. However, the party identification engine 220 may identify other potentially interested parties through the utilization of received documentation from multiple source data stores. In one example, the party identification engine 220, upon receipt of documents A and B from the insurer's database 214, may parse the documentation and discover that parents of an underage driver 1004, an insurance company 1006 and an insurance agent 1008 are identified as interested parties pertaining to a particular insured item, for instance a vehicle. Upon receipt of documents C and D, the party identification engine 220 may parse each document and discover that the documents disclose information leading to the determination that the parents of an underage driver 1004, and a particular court system 1008 may be interested parties. Similarly, the party identification engine 220 may receive documents E and F from the department of motor vehicles database. These documents may indicate that the parents of an underage driver 1004, and a particular court system may be interested parties. The party identification engine 220 may create party identification tuples for identification purposes. A tuple may be used, for example in relational databases, to represent and/or reference an object and/or information about that object. For example, such tuples may serve as unique identifiers and/or relational database table index values. The components of the party identification tuples may be drawn from fields of received documents and matched to corresponding tuples in various databases.

Through this process, the party identification engine 220 may identify parties who have not pre-registered with the secure evidence sharing engine 214. Once the parties are identified and evidentiary documentation is received, the secure evidence sharing engine 214 may notify the discovered parties in a similar manner as described above to indicate that evidentiary documentation may be available for them to access. In this instance, the court and the insurance agent may register through the service, possibly pay a fee depending on the type of documentation available, and gain access to the evidentiary documentation. For the provider of such documentation, the identification of parties who did not self-register is quite beneficial for increasing the likelihood of a greater revenue stream for the provider, than if the provider's documentation was only offered to self-registered parties.

Though the examples above specific reference certain data bases, it should be understood that many other sources of insurance related documentation may be available. For instance, the system may provide an interfaces for databases pertaining to worker's compensation, department of transportation and motor vehicles, county taxes, state insurance commissions, to name a few. Additionally, public companies such as OnStar, CarFax, Lexis/Nexis, ISOClaimsearch are also potential partners and sources of searchable data, which can be mated to the secure evidence sharing engine's 114 data.

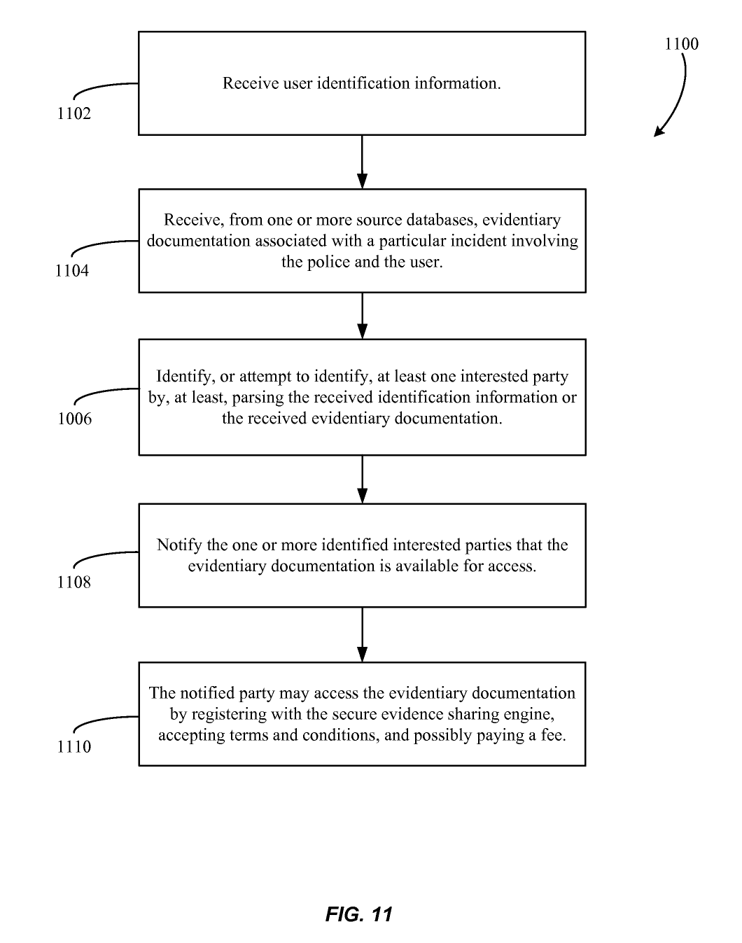

FIG. 11 is a flowchart depicting a process 1100 for implementing features of the secure evidence sharing engine described herein, according to at least one example. In this example, process 1100 may include receiving user identification information at step 1102. As discussed, the user identification information may be gathered from registration information, from evidence requests, or from searchable databases responsible for storing such information. As described above, a client device 204, 206, 208, such as a personal computer, a cell phone, a handheld message device, a laptop computer, a personal data assistant, or the like, may be utilized by the user to submit registration information. The client device 204, 206, 208 may obtain the user's information in various ways including, but not limited to, scanning a bar code, taking a picture of the item, or manual entry of user identification information as well as any combination thereof. The information received from the client device 204, 206, 208 may be used to determine what contact information should be used when notifying the client. The information received from the client device may also be used to determine when the user should be notified based at least in part on the user identification information received from the user or from an external data store responsible for storing such information.

In one example, after receiving user identification information, the secure evidence sharing engine receives, from one or more source databases, evidentiary documentation associated with a particular incident involving the police and the user at step 1104. At step 1106, the party identification engine 1001, a component of the secure evidence sharing engine 201, identifies at least one interested party by, at least, parsing the received identification information or the received evidentiary documentation. The received identification information may include identification information associated with the user and/or identification associated with other parties the user wishes to notify. As discussed, the party identification engine 1001 may draw from information obtained from various external data stores responsible for maintaining insurance documentation and/or evidentiary documentation to discover interested parties.

The client notification engine 230, a component of the secure evidence sharing engine 201, may then notify the identified interested party that the evidentiary documentation is available for access at step 1108. The notified party may then access the evidentiary documentation by registering with the secure evidence sharing engine 201, accepting the terms and conditions via the web site, and possibly paying a fee at step 1110.

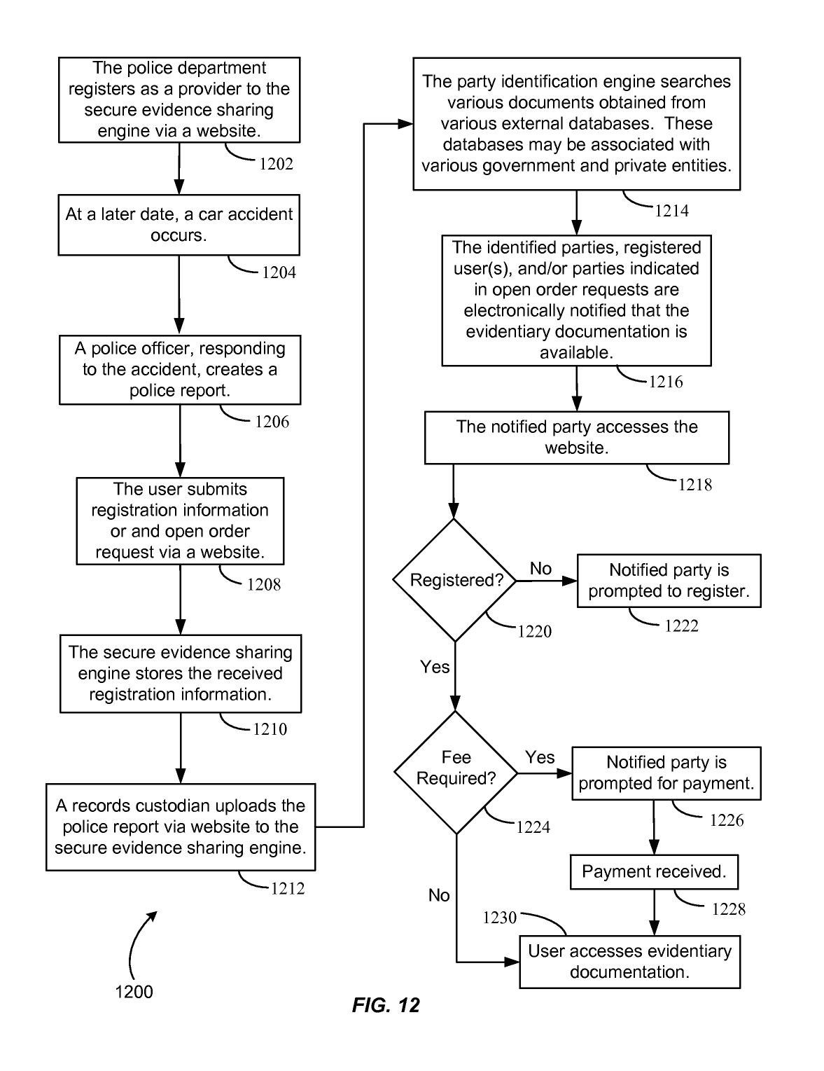

FIG. 12 is a flowchart depicting a process 1200 for implementing additional features of the secure evidence sharing engine described herein, according to at least one example. In this example process 1200, a police department registers via the web site designed to be a graphical user interface 210 for the secure evidence sharing engine 114 at step 1202. At a later date, an accident occurs at step 1204. In accordance with at least one embodiment, one car involved in the accident is one that the user has listed in his or her registration information. A police officer, responding to the accident, creates, for examples, a police report at step 1206. As discussed, the user submits contact and identification information via the registration process or via an evidence request at step 1208. The secure evidence sharing engine 201 may then store the registration data in a data store 214 responsible for the storage of such information at step 1210.

In one example, a records custodian uploads the police report via web site to the secure evidence sharing engine 201 at step 1212. It should be noted that some upload of information may also occur at the scene were the police officer to utilize a scanning device to scan, for instance, the driver's license, or UPC bar code located on the vehicle. The party identification engine 220 searches various documents obtained from various external databases at step 1214. The databases may be associated with various government and private entities. The identified parties, registered users, and/or parties indicated in evidence requests are electronically notified that the evidentiary documentation is available for them to purchase or access at step 1216.

Some time later, a notified party may access the web site, seeking to access the evidentiary documentation at step 1218. The secure evidence sharing engine may determine whether or not the notified party is registered at step 1220. If the notified party is not registered, the notified party may be prompted to go through the registration process at step 1222. If the notified party is registered, the payment processing engine, a component of the secure evidence sharing engine, may determine if a fee is required at step 1224. If a fee is required, the notified party may be prompted for payment at step 1226. Once payment is received at step 1228, the notified party may access the evidentiary documentation at step 1230. If the payment processing engine determines that no fee is required, the notified party may not be prompted for payment and may be immediately enabled to access the evidentiary documentation at step 1230.

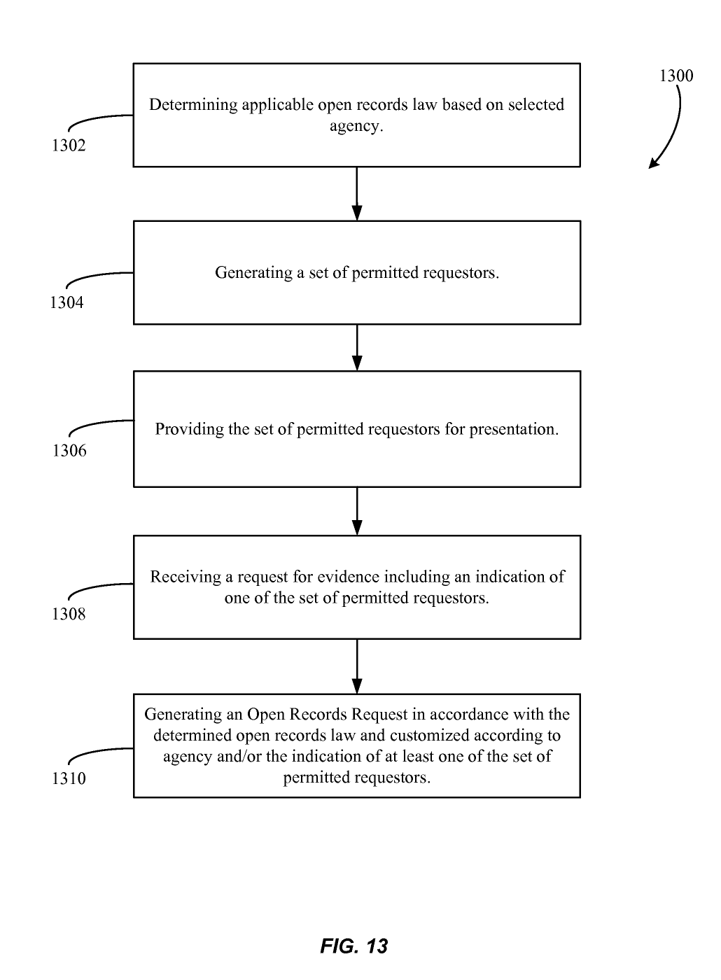

FIG. 13 is a flowchart depicting an example process 1300 in accordance with at least one embodiment. For example, the steps of process 1300 may be performed by the secure evidence sharing engine 201 of FIG. 2. In this example, process 1300 may include determining applicable open records law based on a selected agency at step 1302. In accordance with at least one embodiment, the user may select from a drop down menu (shown in FIG. 4 as 404) the applicable agency. The selection may be used to retrieve the applicable open records law for the jurisdiction associated with the agency. Based on the applicable open records laws retrieved, a set of permitted requestors may be generated at step 1304. The set of permitted requestors may correspond to selections available such as: a party involved in the incident (shown in FIG. 4 as 416), an attorney representing a party to the incident (shown in FIG. 4 as 418), a witness to the incident, an insurance agent for a party to the incident, to name a few. At step 1306, the determined set of permitted requestors may be provided for presentation to a user as part of required fields associated with an evidence request. The user may be required to select at least one permitted requestor selection. Once the user has selected a permitted requestor selection and submitted the evidence request information, the system 114 of FIG. 1 upon reception of such information at step 1308 may generate, in accordance with the determined open records law and customized according to selected agency and/or the indication of at least one of the set of permitted requestors, a legally compliant open records request at step 1310.

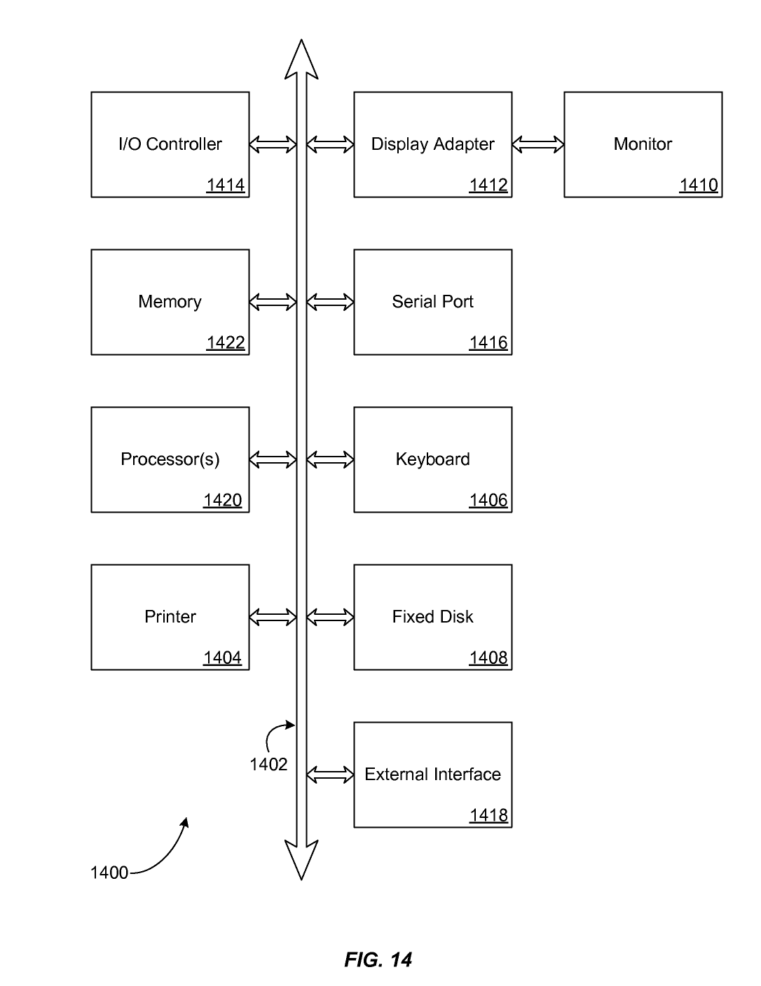

In accordance with at least one embodiment of the invention, the system, apparatus, methods, processes and/or operations for fault tolerance may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system. As an example, FIG. 14 depicts aspects of elements that may be present in a computer device and/or system 1400 configured to implement a method and/or process in accordance with some embodiments of the present invention. The subsystems shown in FIG. 14 are interconnected via a system bus 1402. Additional subsystems include a printer 1404, a keyboard 1406, a fixed disk 1408, and a monitor 1410, which is coupled to a display adapter 1412. Peripherals and input/output (I/O) devices, which couple to an I/O controller 1414, can be connected to the computer system by any number of means known in the art, such as a serial port 1416. The computer system may be made up of one or many computers. The serial port 1416 or an external interface 1418 can be utilized to connect the computer device 1400 to further devices and/or systems not shown in FIG. 14 including a wide area network such as the Internet, a mouse input device, and/or a scanner. The interconnection via the system bus 1402 allows one or more processors 1420 to communicate with each subsystem and to control the execution of instructions that may be stored in a system memory 1422 and/or the fixed disk 1408, as well as the exchange of information between subsystems. The system memory 1422 and/or the fixed disk 1408 may embody a tangible computer-readable medium.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for secure evidence sharing, comprising:
receiving identification information associated with a party;
receiving evidentiary documentation associated with an incident involving law enforcement and the party;
identifying, with a party identification component of a computer system, at least one interested party to notify based at least in part on the received identification information or information associated with the received evidentiary documentation; and
notifying the identified interested party with respect to the received evidentiary documentation.

2. The computer-implemented method of claim 1, further comprising:
subsequent to notifying the identified interested party with respect to the received evidentiary documentation, receiving further evidentiary documentation associated with the incident; and
notifying the at least one interested party with respect to the further evidentiary documentation.

3. The computer-implemented method of claim 1, wherein the identification information associated with the party includes at least one of: an insurance policy number, a vehicle identification number, a name, an email address, and a real property address.

4. The computer-implemented method of claim 1, wherein the party associated with the identification information has declared a legal interest in the object or outcome of the incident involving law enforcement.

5. The computer-implemented method of claim 1, wherein the received identification information is associated with involved in the incident, or a separate party the interested party has identified.

6. The computer-implemented method of claim 1 further comprising;
receiving from a user a request to access the evidentiary documentation;
in response to receiving the request, determining that the user has a legal right to view the evidentiary documentation; and
based on the determination, enabling the user to access the received electronic evidentiary documentation.

7. The computer-implemented method of claim 1, wherein the electronic evidentiary documentation includes an electronic copy of at least one police report, in-car video, officer worn video, eyewitness account, or any document created with the expectation that the document may be used as evidence at trial, or a combination thereof.

8. The computer-implemented method of claim 1, further comprising:
receiving user identification information from a user;
receiving interested party identification information from a provider of interested party identification information;
comparing received user identification information to the received interested party identification information and the received evidentiary documentation; and
determining that the user has a legal right to access the evidentiary documentation when the user identification information matches the received interested party identification information or when the user identification information matches identification information described in the received evidentiary documentation; and
enabling the user to access the evidentiary documentation.

9. The computer-implemented method of claim 8, wherein matching involves receiving data objects from multiple data sources, and determining an appropriate identification tuple for a destination data source that draws attributes from a plurality of the data sources.

10. The computer-implemented method of claim 1, wherein identification information associated with objects or persons is entered by law enforcement officers at the scene of the incident through the use of an electronic device capable of sending and receiving messages over a public network.

11. A system for secure evidence sharing, comprising:
a user interface component configured to, at least:
receive identification information associated with a party;
receive a request for evidentiary documentation from the party; and
receive one or more instances of electronic evidentiary documentation associated with an incident involving law enforcement and the party;
a party identification component configured at least to identify at least one interested party to notify based at least in part on the received identification information or information associated with the received evidentiary documentation; and
a client notification component configured at least to notify the identified interested party with respect to the evidentiary documentation.

12. The system of claim 11, wherein a new component or one of the already mentioned components further configured converts received electronic evidentiary documentation of a first format into electronic evidentiary documentation of a second format.

13. The system of claim 11, wherein receipt of the request for evidentiary documentation causes the party identification component to identify one or more providers of the requested evidentiary document and the client notification component to send one or more notifications to the one or more providers of the requested evidentiary documentation.

14. The system of claim 11, wherein receipt of each of the one or more instances of evidentiary documentation causes one or more components to identify interested parties and notify the identified parties with respect to the evidentiary documentation.

15. The system of claim 11, wherein the received electronic evidentiary documentation is received from a component in or incorporated by an evidence collector located remotely with respect to the system.

16. The system of claim 11, wherein a new component or one of the already mentioned components further configured at least determines a fee to charge the user for access to the electronic evidentiary documentation.

17. The system of claim 16, wherein the fee determination is based at least in part on the selection by the user of at least one of: a flat fee, a bulk ordering discounted fee plan, or a fee sharing agreement.

18. A non-transitory computer-readable storage medium for secure evidence sharing including instructions that, when executed by at least one processor, cause at least one computer to, at least:
receive identification information associated with a party;
receive electronic evidentiary documentation associated with an incident involving law enforcement and the party;
identify at least one interested party to notify based at least in part on the received identification information or information associated with the received evidentiary documentation; and
notify the identified interested party with respect to the evidentiary documentation.

19. The non-transitory computer-readable storage medium of claim 18, wherein the instructions further cause the computer at least to determine a length of storage time based at least in part on a defined statutory time period and a length of storage time purchased by the user.

20. The non-transitory computer-readable storage medium of claim 18, wherein the instructions further cause the computer to, at least:
receive indication from the interested party regarding instances in which the interested party agrees to be charged for access to the evidentiary documentation without requiring further approval; and
in response to receiving the evidentiary documentation, determine based at least in part on the received interested party indication when to collect a fee and provide access of evidentiary documentation to an interested party.
